(19) United States
(12) Patent Application Publication
(10) Pub. No.: US 2016/0147136 A1
(43) Pub. Date: May 26, 2016

(54) WAVELENGTH CONVERSION ELEMENT, LIGHT SOURCE DEVICE, PROJECTOR, AND METHOD FOR MANUFACTURING WAVELENGTH CONVERSION ELEMENT

(71) Applicant: SEIKO EPSON CORPORATION, Tokyo (JP)

(72) Inventor: Shigeo NOJIMA, Azumino-shi (JP)

(73) Assignee: SEIKO EPSON CORPORATION, Tokyo (JP)

(21) Appl. No.: 14/942,364

(22) Filed: Nov. 16, 2015

(30) Foreign Application Priority Data
Nov. 25, 2014 (JP) 2014-237686

(51) Int. Cl. G03B 21/20; G03B 21/00

(52) U.S. Cl. CPC G03B 21/204; G03B 21/2013; G03B 21/006; G03B 21/2066

(57) ABSTRACT

The invention relates to a wavelength conversion element including: a phosphor layer including a first surface and fluorescence-emitting points dispersed therein; a reflection surface provided on the opposite side of the phosphor layer from the first surface; and a substrate provided on the opposite side of the reflection surface from the phosphor layer. The phosphor layer includes a first region on the first surface side and a second region located between the first region and the reflection surface. A concentration of the fluorescence-emitting points in the second region is higher than a concentration of the fluorescence-emitting points in the first region.

### BACKGROUND

1. Technical Field

The present invention relates to a wavelength conversion element, a light source device, a projector, and a method for manufacturing the wavelength conversion element.

2. Related Art

In recent years, a light source device utilizing a phosphor is used in a projector. In the light source device, excitation light is converted into fluorescence by a phosphor layer including phosphor particles dispersed therein, and the fluorescence is emitted from the phosphor layer (e.g., refer to JP-A-2009-170723).

In the related art, however, since the phosphor particles are uniformly dispersed in the phosphor layer, most of the excitation light is absorbed by the phosphor particles and converted into the fluorescence on the excitation light incident side of the phosphor layer, which reduces the excitation light reaching deeply into the phosphor layer. Therefore, heat generation disproportionately occurs on the excitation light incident side in the phosphor layer, and thus the temperature rises excessively on the excitation light incident side. Therefore, there is a problem that a reduction in conversion efficiency due to a high temperature occurs and thus the efficiency of conversion of the excitation light into the fluorescence is reduced as a whole.

### SUMMARY

An advantage of some aspects of the invention is to provide a wavelength conversion element by which fluorescence is efficiently generated. Another advantage of some aspects of the invention is to provide a light source device including the wavelength conversion element, a projector including the light source device, and a method for manufacturing the wavelength conversion element.

A first aspect of the invention provides a wavelength conversion element including: a phosphor layer including a first surface and fluorescence-emitting points dispersed therein; a reflection surface provided on the opposite side of the phosphor layer from the first surface; and a substrate provided on the opposite side of the reflection surface from the phosphor layer, wherein the phosphor layer includes a first region on the first surface side and a second region located between the first region and the reflection surface, and a concentration of the fluorescence-emitting points in the second region is higher than a concentration of the fluorescence-emitting points in the first region.

According to the wavelength conversion element according to the first aspect, since the concentration of the fluorescence-emitting points on the excitation light incident side is relatively low, the excitation light can reach deeply into the phosphor layer. Due to this, heat-generating regions where heat is generated by the fluorescence conversion are brought into a state of being dispersed in the thickness direction of the phosphor layer.

Moreover, there is a possibility that the amount of heat generation increases in the vicinity of the substrate where the concentration of the fluorescence-emitting points is relatively high. However, since the heat is dissipated to the outside via the substrate, the phosphor layer can be efficiently cooled.

Hence, since a reduction in conversion efficiency due to a high temperature is unlikely to occur, fluorescence is efficiently generated.

A second aspect of the invention provides a light source device including: a light-emitting element that emits excitation light to excite the fluorescence-emitting points; and the wavelength conversion element according to the first aspect.

According to the light source device according to the second aspect, the wavelength conversion element according to the first aspect, which efficiently generates fluorescence, is included, so that bright light can be emitted.

A third aspect of the invention provides a projector including: an illumination device that emits illumination light; a light modulator that modulates the illumination light in response to image information to thereby form image light; and a projection optical system that projects the image light, wherein the illumination device is the light source device according to the second aspect.

According to the projector according to the third aspect, the light source device according to the second aspect is included, so that the projector can perform bright display with excellent image quality.

A fourth aspect of the invention provides a method for manufacturing a wavelength conversion element including a substrate, a reflection surface provided on the substrate, and a phosphor layer provided on the reflection surface and including fluorescence-emitting points dispersed therein, the method including: forming, above the reflection surface, a second phosphor film having a second fluorescence-emitting point concentration; and forming, above the second phosphor film, a first phosphor film having a first fluorescence-emitting point concentration lower than the second fluorescence-emitting point concentration.

According to the method for manufacturing the wavelength conversion element according to the fourth aspect, it is possible to manufacture the wavelength conversion element in which the excitation light reaches deeply into the phosphor layer, and heat-generating regions caused by the fluorescence conversion are dispersed in the thickness direction of the phosphor layer.

According to the wavelength conversion element, heat generated in the vicinity of the substrate where the concentration of the fluorescence-emitting points is relatively high is dissipated to the outside via the substrate, so that the phosphor layer can be efficiently cooled.

Hence, a reduction in conversion efficiency due to a high temperature is unlikely to occur, so that it is possible to provide the wavelength conversion element that efficiently generates fluorescence.

### BRIEF DESCRIPTION OF THE DRAWINGS

The invention will be described with reference to the accompanying drawings, wherein like numbers reference like elements.

FIG. 1 is a top view showing an optical system of a projector according to an embodiment.

FIG. 2A is an elevation view of a rotating fluorescent plate, and FIG. 2B is a cross-sectional view taken along the line A1-A1 in FIG. 2A.

### DESCRIPTION OF EXEMPLARY EMBODIMENTS

Hereinafter, embodiments of the invention will be described in detail with reference to the drawings.

In the drawings used in the following description, a characteristic portion is shown in an enlarged manner in some cases for convenience for clarity of the characteristic, and thus the dimension ratio and the like of each component are not always the same as actual ones.

One example of a projector according to an embodiment will be described. The projector of the embodiment is a projection type image display device that displays a color video on a screen (projected surface) SCR. The projector includes three liquid crystal light modulators corresponding to respective color lights: red light, green light, and blue light. The projector includes, as light sources of illumination devices, semiconductor lasers with which high-luminance, high-output light is obtainable.

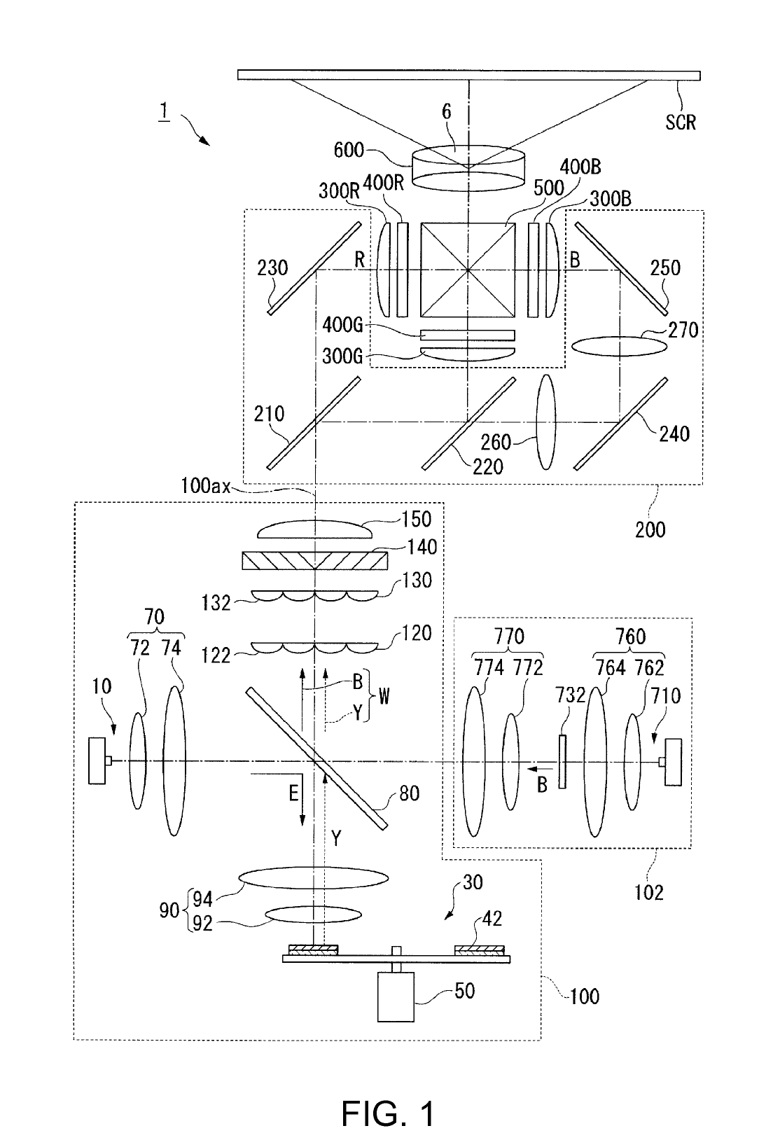

FIG. 1 is a top view showing an optical system of the projector according to the embodiment.

As shown in FIG. 1, the projector 1 includes a first illumination device 100, a second illumination device 102, a color separation and light guiding optical system 200, liquid crystal light modulators 400R, 400G, and 400B, a cross dichroic prism 500, and a projection optical system 600.

The first illumination device 100 includes a first light source 10, a collimating optical system 70, a dichroic mirror 80, a collimating and condensing optical system 90, a rotating fluorescent plate (wavelength conversion element) 30, a motor 50, a first lens array 120, a second lens array 130, a polarization conversion element 140, and a superimposing lens 150.

The first light source 10 is composed of a semiconductor laser (light-emitting element) that emits, as excitation light, blue light (emission intensity peak: about 445 nm) E composed of a laser beam. The first light source 10 may be composed of one semiconductor laser, or may be composed of a number of semiconductor lasers.

For the first light source 10, a semiconductor laser that emits blue light at a wavelength other than 445 nm (e.g., 460 nm) can also be used.

In the embodiment, the first light source 10 is disposed such that the optical axis thereof is orthogonal to an illumination optical axis 100ax.

The collimating optical system 70 includes a first lens 72 and a second lens 74, and substantially collimates the light from the first light source 10. The first lens 72 and the second lens 74 are each composed of a convex lens.

The dichroic mirror 80 is disposed, in an optical path from the collimating optical system 70 to the collimating and condensing optical system 90, so as to cross each of the optical axis of the first light source 10 and the illumination optical axis 100ax at an angle of 45°. The dichroic mirror 80 reflects blue light B while allowing yellow fluorescence Y including red light and green light to pass therethrough.

The collimating and condensing optical system 90 has two functions: one is to cause the blue light E from the dichroic mirror 80 to be incident in a substantially condensed state on a phosphor layer 42 of the rotating fluorescent plate 30; and the other is to substantially collimate fluorescence emitted from the rotating fluorescent plate 30. The collimating and condensing optical system 90 includes a first lens 92 and a second lens 94. The first lens 92 and the second lens 94 are each composed of a convex lens.

The second illumination device 102 includes a second light source 710, a condensing optical system 760, a scattering plate 732, and a collimating optical system 770.

The second light source 710 is composed of a semiconductor laser of the same type as that of the first light source 10 of the first illumination device 100.

The condensing optical system 760 includes a first lens 762 and a second lens 764. The condensing optical system 760 collects blue light from the second light source 710 near the scattering plate 732. The first lens 762 and the second lens 764 are each composed of a convex lens.

The scattering plate 732 scatters the blue light from the second light source 710 to make the blue light into the blue light B having a light distribution similar to a light distribution of the fluorescence emitted from the rotating fluorescent plate 30. As the scattering plate 732, for example, frosted glass composed of optical glass can be used.

The collimating optical system 770 includes a first lens 772 and a second lens 774, and substantially collimates the light from the scattering plate 732. The first lens 772 and the second lens 774 are each composed of a convex lens.

In the embodiment, the blue light B from the second illumination device 102 is reflected by the dichroic mirror 80, and combined with the fluorescence Y emitted from the rotating fluorescent plate 30 and having transmitted through the dichroic mirror 80 to constitute white light W. The white light W is incident on the first lens array 120.

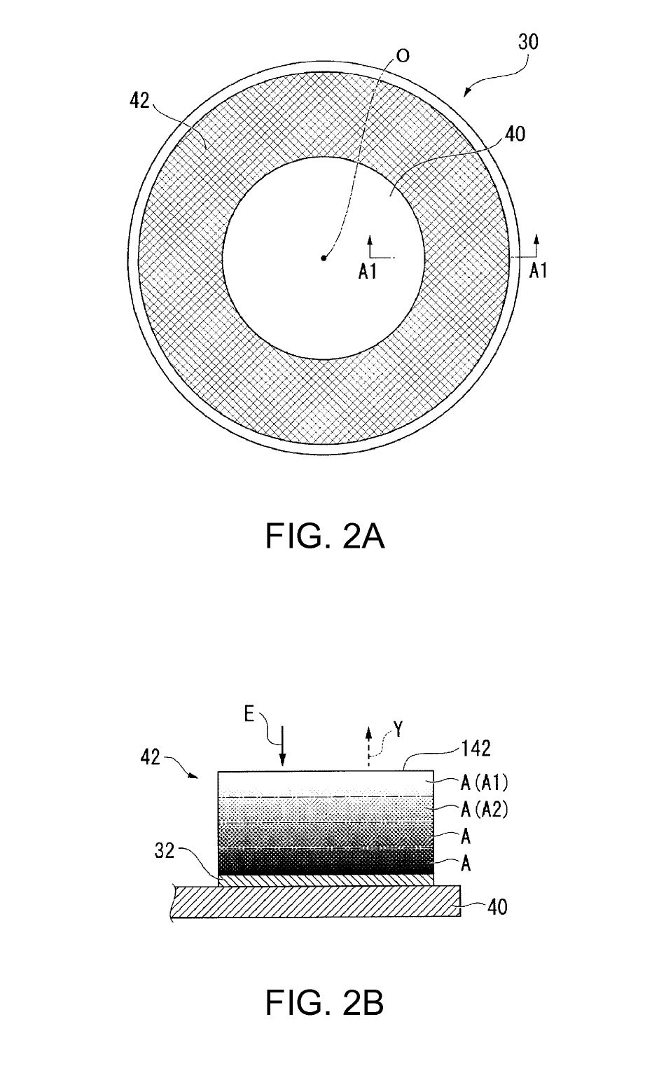

FIGS. 2A and 2B show the rotating fluorescent plate according to an embodiment. FIG. 2A is an elevation view of the rotating fluorescent plate 30, and FIG. 2B is a cross-sectional view taken along the line A1-A1 in FIG. 2A.

As shown in FIGS. 1 to 2B, the rotating fluorescent plate 30 is formed by providing the phosphor layer 42 on a circular disk (substrate) 40 that is rotatable by the motor 50, along the periphery of the circular disk 40. The phosphor layer 42 is formed in, for example, a ring shape. The rotating fluorescent plate 30 emits the fluorescence Y toward the same side as that on which the blue light is incident. That is, the rotating fluorescent plate 30 includes the phosphor layer 42 having a light incident surface (first surface) 142 on which the blue light E is incident, a reflection film (reflection surface) 32 provided on the opposite side of the phosphor layer 42 from the light incident surface 142, and the circular disk 40 provided on the opposite side of the reflection film 32 from the phosphor layer 42.

The phosphor layer 42 is excited by the blue light E from the first light source 10 to thereby emit the fluorescence Y. The phosphor layer 42 includes phosphor particles 42a (not shown) that serve as fluorescence-emitting points and a binder material 42b (not shown) that holds the phosphor particles 42a. The phosphor particle 42a is composed of, for example, (Y,Gd)₃(Al,Ga)₅O₁₂:Ce, which is a YAG-based phosphor. It is sufficient for the binder material 42b to have a light transmitting property to transmit at least the blue light E and the fluorescence Y, and the binder material 42b is composed of, for example, silicone resin.

In the embodiment, the phosphor layer 42 includes a plurality of regions A arranged along the axial direction of an axis O of rotation of the rotating fluorescent plate 30. Here, a certain region A on the light incident surface 142 side on which the blue light E is incident is defined as a first region A1, and a certain region A located between the first region A1 and the reflection film 32 is defined as a second region A2.

When the first region A1 is compared with the second region A2, the amount of the phosphor particles 42a (hereinafter also referred to as “fluorescence-emitting point concentration”) relative to the binder material 42b is different. The fluorescence-emitting point concentration in the second region A2 is higher than the fluorescence-emitting point concentration in the first region A1. In the embodiment, the fluorescence-emitting point concentration continuously increases every region A, for example, from the light incident surface 142 side to the reflection film 32 side in the phosphor layer 42 in its thickness direction (axial direction of the axis O of rotation).

The region A may be referred to as “phosphor film”. In this case, the first region A1 is referred to as “first phosphor film”, and the second region A2 is referred to as “second phosphor film”.

For the phosphor layer 42 of the embodiment, an example in which the fluorescence-emitting point concentration continuously changes (increases) every region A has been presented. However, the invention is not limited to this example.

For example, it is sufficient for the phosphor layer 42 to include, in the plurality of regions A, a structure in which the second region A2 having a fluorescence-emitting point concentration higher than that of the first region A1 is located between the first region A1 and the reflection film 32. That is, the phosphor layer 42 may include, between the first region A1 and the second region A2, a region having a fluorescence-emitting point concentration lower than the fluorescence-emitting point concentration of the first region A1.

The circular disk 40 is composed of, for example, a circular disk made of metal having an excellent heat dissipation property such as aluminum or copper. The reflection film 32 is composed of, for example, an Ag alloy, and reflects the fluorescence Y and thereby allows the fluorescence Y to exit from the light incident surface 142 side to the outside. An adhesive layer (not shown) is provided between the reflection film 32 and the circular disk 40. The adhesive layer is, for example, a high thermal conductive silicone adhesive containing Ag fillers and efficiently conducts heat of the phosphor layer 42 to the circular disk 40 side via the reflection film 32.

Here, an example of a method for manufacturing the rotating fluorescent plate 30 of the embodiment will be described.

First, the circular disk 40 provided with the reflection film 32 is prepared. The reflection film 32 may be attached to the circular disk 40 using a high thermal conductive silicone adhesive containing the fillers, or may be formed directly on the circular disk 40.

Subsequently, the phosphor layer 42 is formed on the reflection film 32.

In the formation of the phosphor layer 42, a base material of the phosphor layer 42 is first prepared. For example, a silicone adhesive serving as the binder material 42b and the phosphor particles 42a are mixed together at, for example, a ratio of 1:1. The mixture is stirred by a vacuum mixer under predetermined conditions (e.g., at 700 Pa and at 3000 rpm for 5 minutes) to form the base material. The base material is printed on the reflection film 32 to a thickness of, for example, 90 μm in a ring shape shown in FIG. 2A.

In the embodiment, the base material printed on the reflection film 32 is left for a predetermined time (e.g., 20 minutes). Due to this, in the base material printed on the reflection film 32, the phosphor particles 42a start to settle down under their weight.

After the phosphor particles 42a settle down such that the concentration of the phosphor particles 42a has a distribution in the thickness direction of the base material, the base material is cured by heating to form the phosphor layer 42. Due to this, the phosphor layer 42 in which the fluorescence-emitting point concentration continuously increases from the light incident surface 142 side to the reflection film 32 side is obtained.

The motor 50 is attached to the circular disk 40, so that the rotating fluorescent plate 30 is manufactured.

In a related-art phosphor layer, phosphor particles are uniformly dispersed in a binder material. Therefore, when blue light (excitation light) is incident on the related-art phosphor layer, most of the blue light is absorbed by the phosphor particles and converted into fluorescence on the light incident surface side. Hence, it is difficult to make the fluorescence reach the deep side (reflection film side) of the phosphor layer.

Moreover, since most of the blue light is absorbed on the light incident surface side, the amount of heat generation increases on the light incident surface side, and thus the temperature rises excessively on the light incident surface side. Therefore, conversion efficiency is reduced due to a high temperature, which reduces the efficiency of conversion into fluorescence on the light incident surface side. Hence, the efficiency of conversion of the blue light into the fluorescence is reduced as a whole in the related-art phosphor layer.

In contrast, since the fluorescence-emitting point concentration on the light incident surface 142 side is relatively low in the phosphor layer 42 of the embodiment, the absorption of the entire blue light E, which has entered through the light incident surface 142, by the phosphor particles 42a on the light incident surface 142 side is suppressed.

Moreover, since the fluorescence-emitting point concentration increases toward the reflection film 32 side in the phosphor layer 42, the blue light E, which has entered through the light incident surface 142, is gradually converted into the fluorescence Y as the blue light E travels to the reflection film 32 side. Hence, at least a portion of the blue light E, which has entered through the light incident surface 142, can reach the deep side (the reflection film 32 side) of the phosphor layer 42 compared to the related art.

The phosphor layer 42 can convert the blue light E into the fluorescence Y substantially over the entire region in the thickness direction. Due to this, heat-generating regions caused by the fluorescence conversion can be brought into a state of being dispersed in the thickness direction in the phosphor layer 42.

According to the phosphor layer 42 of the embodiment as described above, a reduction in conversion efficiency due to a high temperature is unlikely to occur. Therefore, the efficiency of conversion into the fluorescence Y can be improved more than that in the related art.

Moreover, there is a possibility in the phosphor layer 42 that the amount of heat generation increases in the vicinity of the reflection film 32 where the fluorescence-emitting point concentration is relatively high. However, since the reflection film 32 is formed on the circular disk 40 having an excellent heat conducting property, the heat of the phosphor layer 42 is efficiently dissipated to the outside via the circular disk 40. Hence, the phosphor layer 42 can be efficiently cooled, and thus a reduction in conversion efficiency due to a high temperature is unlikely to occur.

Referring back to FIG. 1, the first lens array 120 includes a plurality of first small lenses 122 for dividing the light from the dichroic mirror 80 into a plurality of partial light beams. The plurality of first small lenses 122 are arranged in a matrix in a plane orthogonal to the illumination optical axis 100ax.

The second lens array 130 includes a plurality of second small lenses 132 corresponding to the plurality of first small lenses 122 of the first lens array 120. The second lens array 130 forms, together with the superimposing lens 150, images of the first small lenses 122 of the first lens array 120 in the vicinity of an image forming region of each of the liquid crystal light modulators 400R, 400G, and 400B. The plurality of second small lenses 132 are arranged in a matrix in a plane orthogonal to the illumination optical axis 100ax.

The polarization conversion element 140 converts each of the partial light beams divided by the first lens array 120 into linearly polarized light. The polarization conversion element 140 includes: a polarization separation layer that transmits, as it is, one linearly polarized component of polarized components included in the light from the rotating fluorescent plate 30 while reflecting the other linearly polarized component in a direction vertical to the illumination optical axis 100ax; a reflection layer that reflects the other linearly polarized component reflected by polarization separation layer in a direction parallel to the illumination optical axis 100ax; and a retardation film that converts the other linearly polarized component reflected by the reflection layer into the one linearly polarized component.

The superimposing lens 150 collects the partial light beams from the polarization conversion element 140 to superimpose on each other in the vicinity of the image forming region of each of the liquid crystal light modulators 400R, 400G, and 400B. The first lens array 120, the second lens array 130, and the superimposing lens 150 constitute an integrator optical system that uniforms an in-plane light intensity distribution of the light from the rotating fluorescent plate 30.

The color separation and light guiding optical system 200 includes dichroic mirrors 210 and 220, reflection mirrors 230, 240, and 250, and relay lenses 260 and 270. The color separation and light guiding optical system 200 separates the white light W from the first illumination device 100 and the second illumination device 102 into red light R, green light G, and blue light B, and guides the red light R, the green light G, and the blue light B to the liquid crystal light modulators 400R, 400G, and 400B respectively corresponding thereto.

Field lenses 300R, 300G, and 300B are disposed between the color separation and light guiding optical system 200 and the liquid crystal light modulators 400R, 400G, and 400B.

The dichroic mirror 210 is a dichroic mirror that allows a red light component to pass therethrough and reflects a green light component and a blue light component.

The dichroic mirror 220 is a dichroic mirror that reflects the green light component and allows the blue light component to pass therethrough.

The reflection mirror 230 is a reflection mirror that reflects the red light component.

The reflection mirrors 240 and 250 are reflection mirrors that reflect the blue light component.

The red light having passed through the dichroic mirror 210 is reflected by the reflection mirror 230, passes through the field lens 300R, and is incident on the image forming region of the liquid crystal light modulator 400R for red light.

The green light reflected by the dichroic mirror 210 is further reflected by the dichroic mirror 220, passes through the field lens 300G, and is incident on the image forming region of the liquid crystal light modulator 400G for green light.

The blue light having passed through the dichroic mirror 220 passes through the relay lens 260, the reflection mirror 240 and the relay lens 270 on the incident side, and the reflection mirror 250 and the field lens 300B on the exiting side, and is incident on the image forming region of the liquid crystal light modulator 400B for blue light.

The liquid crystal light modulators 400R, 400G, and 400B modulate the incident color lights in response to image information to form color images corresponding to the respective color lights. Although not shown in the drawing, an incident-side polarizer is disposed between each of the field lenses 300R, 300G, and 300B and each of the liquid crystal light modulators 400R, 400G, and 400B, and an exiting-side polarizer is disposed between each of the liquid crystal light modulators 400R, 400G, and 400B and the cross dichroic prism 500.

The cross dichroic prism 500 is an optical element that combines the respective image lights emitted from the liquid crystal light modulators 400R, 400G, and 400B to form a color image.

The cross dichroic prism 500 has substantially a square shape, in a plan view, obtained by bonding four right-angle prisms together, and dielectric multilayer films are formed on substantially X-shaped interfaces at which the right-angle prisms are bonded together.

The color image emitted through the cross dichroic prism 500 is enlarged and projected by the projection optical system 600, so that an image is formed on the screen SCR.

As described above, since the projector 1 of the embodiment includes the first illumination device 100 that efficiently generates and emits the fluorescence Y, the projector 1 can display an image having excellent quality.

The invention is not necessarily limited to the embodiments, and various modifications can be added within the scope not departing from the gist of the invention.

In the embodiment, an example in which after the base material of the phosphor layer 42 is printed, the base material is left for a predetermined time to cause the phosphor particles 42a to settle down has been mentioned as the method for manufacturing the phosphor layer 42. However, the invention is not limited to this example.

For example, the phosphor layer 42 in which the fluorescence-emitting point concentration varies in the thickness direction may be manufactured by repeating more than once the step of printing the base material on the circular disk 40 and curing the base material by heating.

For example, the step of printing the base material on the reflection film 32 and curing the base material by heating may be repeated three times. In this case, as a base material used in the first step, a base material obtained by mixing a silicone adhesive with the phosphor particles 42a at a ratio of, for example, 1:1.5 is used. Due to this, the second phosphor film having the highest fluorescence-emitting point concentration is formed. In the second step, as a base material to be stacked on the base material printed in the first step, a base material obtained by mixing the silicone adhesive with the phosphor particles 42a at a ratio of, for example, 1.5:1 is used. In the third step, as a base material to be stacked on the base material printed in the second step, a base material obtained by mixing the silicone adhesive with the phosphor particles 42a at a ratio of, for example, 3:1 is used. Due to this, the first phosphor film having the lowest fluorescence-emitting point concentration is formed. In this case, a phosphor film having an intermediate fluorescence-emitting point concentration is formed between the first phosphor film and the second phosphor film.

Also in the manufacturing method described above, it is possible to easily manufacture the rotating fluorescent plate 30 having the structure in which the fluorescence-emitting point concentration increases from the light incident surface 142 side toward the reflection film 32 side in the thickness direction.

Moreover, although the phosphor layer including the plurality of phosphor particles 42a has been illustrated as the phosphor layer 42 in the embodiment, the invention is not limited to this phosphor layer. For example, fluorescent bulk ceramics in which the concentration distribution of fluorescence-emitting ions that emit fluorescence is adjusted may be used. The fluorescence-emitting ion corresponds to the fluorescence-emitting point in the invention.

The fluorescent bulk ceramics described above can be manufactured by, for example, stacking a plurality of ceramic sheets having different fluorescence-emitting ion concentrations from one another in descending order of the fluorescence-emitting ion concentration and sintering the ceramic sheets. In the case of manufacturing the fluorescent bulk ceramics as described above, since a common process for manufacturing ceramics can be applied, there are no limitations on shape, dimension, and the like, and thus a phosphor layer having a high degree of design freedom can be provided.

Moreover, if a bulk-shaped phosphor layer is adopted, the resin as the binder material is not needed. Therefore, compared to the phosphor layer 42 using the resin as the binder material, it is possible to achieve a longer life and the usage under a higher temperature environment.

Moreover, although the projector 1 including the three liquid crystal light modulators 400R, 400G, and 400B has been illustrated in the embodiment, the invention can also be applied to a projector that displays a color video with one liquid crystal light modulator. Moreover, a digital mirror device may be used as a light modulator.

Moreover, although an example of mounting the illumination device according to the invention on the projector has been shown in the embodiment, the invention is not limited to this example. The illumination device according to the invention can be applied also to a luminaire, a headlight of an automobile, or the like.

The entire disclosure of Japanese Patent Application No. 2014-237686, filed on Nov. 25, 2014 is expressly incorporated by reference herein.

What is claimed is:

1. A wavelength conversion element comprising:
a phosphor layer including a first surface and fluorescence-emitting points dispersed therein;
a reflection surface provided on the opposite side of the phosphor layer from the first surface; and
a substrate provided on the opposite side of the reflection surface from the phosphor layer, wherein the phosphor layer includes a first region on the first surface side and a second region located between the first region and the reflection surface, and
a concentration of the fluorescence-emitting points in the second region is higher than a concentration of the fluorescence-emitting points in the first region.

2. A light source device comprising:
a light-emitting element that emits excitation light to excite the fluorescence-emitting points; and
the wavelength conversion element according to claim 1.

3. A projector comprising:
an illumination device that emits illumination light;
a light modulator that modulates the illumination light in response to image information to thereby form image light; and
a projection optical system that projects the image light, wherein
the illumination device is the light source device according to claim 2.

4. A method for manufacturing a wavelength conversion element including
a substrate,
a reflection surface provided on the substrate, and
a phosphor layer provided on the reflection surface and including fluorescence-emitting points dispersed therein, the method comprising:
forming, above the reflection surface, a second phosphor film having a second fluorescence-emitting point concentration; and
forming, above the second phosphor film, a first phosphor film having a first fluorescence-emitting point concentration lower than the second fluorescence-emitting point concentration.
